(19) United States
(12) Patent Application Publication
(10) Pub. No.: US 2026/0236045 A1
(43) Pub. Date: Aug. 13, 2026

(54) MANAGEMENT OF SOLAR POWER DELIVERED TO LAND SHARED BY SOLAR TRACKERS AND AGRICULTURE

(71) Applicant: Nextpower LLC, Fremont, CA (US)

(72) Inventors: Venkata Sai Rahul Abbaraju, Fremont, CA (US); Amir Shishavan, Fremont, CA (US); Matthias Krause, Fremont, CA (US)

(21) Appl. No.: 19/530,954

(22) Filed: Feb. 5, 2026

Related U.S. Application Data
(60) Provisional application No. 63/756,121, filed on Feb. 8, 2025.

(51) Int. Cl. G05D 3/10; H02J 3/00; H02J 101/24; H02J 103/50; H02S 20/32

(52) U.S. Cl. CPC G05D 3/105; H02J 3/004; H02S 20/32; H02J 2101/25; H02J 2103/50

(57) ABSTRACT

A method of managing solar power delivered to land shared by solar trackers and agriculture includes receiving an input for a specified amount of light during a specified time frame. The specified amount of light is a portion of total insolation received by the plurality of solar trackers during the specified timeframe. The method also includes adjusting one or more angles of the plurality of solar trackers during the specified timeframe to increase an amount of insolation on the one or more crops by at least the specified amount of light. The method further includes adjusting the one or more angles of the plurality of solar trackers to one or more PV-optimized angles outside of the specified timeframe with the one or more PV-optimized angles corresponding to angles that maximize energy production of the plurality of solar trackers.

### RELATED APPLICATIONS

This application claims the benefit of U.S. Provisional Patent Application No. 63/756,121, filed Feb. 8, 2025, the entire contents of which are incorporated herein by reference.

### TECHNICAL FIELD

This disclosure generally relates to solar energy systems for managing a solar resource between electricity generation and agriculture.

### BACKGROUND

Solar energy systems having photovoltaic (PV) arrays are commonly deployed to capture energy from the Sun via capturing solar irradiance. PV arrays serve to generate electricity when solar illumination is incident upon the arrays with the generated electricity often being fed into an electrical grid. Tracking PV systems have been developed in which PV arrays are pivoted to capture more solar irradiance than non-tracking PV systems by reducing the losses of direct solar irradiance upon the PV arrays.

The demand for solar electricity has continually increased. However, solar energy systems that produce large amounts of electricity generally require a correspondingly large amount of suitable land. In some locations, there is a shortage of suitable, available land for such solar energy systems. Attempts have been made to try to install PV arrays where crops are grown. However, this leads to a conflict between PV arrays and the plants which both require the Sun's energy, for generating electricity and growing crops, respectively.

### SUMMARY

In general, this disclosure describes systems and methods for managing solar power delivered to land that is shared by solar trackers and agriculture. In particular, this disclosure describes systems and methods utilizing user input related to a split of solar energy between a solar system and agriculture to control orientations of rows of solar trackers of the solar system to thereby obtain the user's desired split of solar energy between the solar system and the agriculture.

Advantages of the systems and methods described herein include a solar system that can inform a user and that is configurable by the user to split solar energy between solar trackers that generate electricity, and crops. A user can alter the amount of light/insolation easily with a selectable amount of granularity to optimize the combined solar system and agriculture according to the user's desires. A controller can be configured to use both user inputs and other inputs (e.g., external or intrinsic inputs) to effectuate the optimization of the combined solar system and agriculture according to various modes of operation of the solar system. Thus, a user can achieve a desired trade-off between growth of agriculture (e.g., crops) and a desired amount of electrical generation for their combined system.

In an example method of operating a solar plant, the solar plant includes a plurality of solar trackers with each of the plurality of solar trackers being located proximate to one or more crops planted in the ground and configured to selectively shade the one or more crops. The method of operating the solar plant includes receiving an input for a specified amount of light during a specified timeframe, the specified amount of light being a portion of total insolation received by the plurality of solar trackers during the specified timeframe. The method can further include adjusting one or more angles of the plurality of solar trackers during the specified timeframe to increase an amount of insolation on the one or more crops by at least the specified amount of light. The method can additionally include adjusting the one or more angles of the plurality of solar trackers to one or more PV-optimized angles outside of the specified timeframe with the one or more PV-optimized angles corresponding to angles that maximize energy production of the plurality of solar trackers.

In another example method of operating a solar plant comprising a plurality of solar trackers, the method includes receiving, at a user interface, an input for a first amount of light during a first specified timeframe. The first amount of light can correspond to a portion of total insolation to be received by the plurality of solar trackers during the first specified timeframe and the input can correspond to a change in operation of the plurality of solar trackers during the first specified timeframe. The method can also include determining, based on the input, a predicted change in total insolation received by the plurality of solar trackers and/or the corresponding change in the generated electricity based on the input for the first amount of light during the first specified timeframe. The method can additionally include determining, based on the input, a predicted change in total insolation received at the ground below the plurality of solar trackers based on the input for the first amount of light during the first specified timeframe. The method can further include displaying the change in the total insolation received by the plurality of solar trackers, the corresponding change in the generated electricity, and/or the change in the total insolation received at the ground below the plurality of solar trackers via the user interface. The method can also include outputting a control signal with the control signal configured to adjust one or more orientations of the plurality of solar trackers to change the total insolation received by the plurality of solar trackers and/or the change in the generated electricity based on the input for the first amount of light during the first specified timeframe.

In another example, a solar plant system can include a first row of solar trackers configured to rotate about a first axis and a second row of solar trackers configured to rotate about a second axis. The second axis can be substantially parallel to the first axis and the second row of solar trackers can be spaced apart from the first row of solar trackers by a first distance. The solar plant system can also include one or more crops planted between the first row of solar trackers and the second row of solar trackers and includes a controller in communication with the first row of solar trackers and the second row of solar trackers. The controller can be configured to determine a predicted maximum amount of insolation received by one or more of the first row of solar trackers, the second row of solar trackers, or at the one or more crops during one or more timeframes. The controller can also be configured to receive an input for a first specified amount of light during a first specified timeframe with the first specified amount of light being a portion of the maximum amount of insolation received at the first row of solar trackers and/or the second row of solar trackers during the first specified timeframe. The controller can further be configured to control the first row of solar trackers and/or the second row of solar trackers to rotate during the first specified timeframe to increase an amount of insolation on the one or more crops by at least the first specified amount of light. The controller can additionally be configured to control the first row of solar trackers and/or the second row of solar trackers to rotate to maximize total energy production of one or both of the first row of solar trackers and the second row of solar trackers outside of the first specified timeframe.

The details of one or more examples are set forth in the accompanying drawings and the description below. Other features, objects, and advantages will be apparent from the description and drawings, and from the enumerated embodiments.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic perspective view of an example solar system with shared agriculture according to an aspect of the present disclosure.

FIG. 2A is a side schematic view of example solar trackers in a first position with shared agriculture according to an aspect of the present disclosure.

FIG. 2B is a side schematic view of example solar trackers in a second position with shared agriculture according to an aspect of the present disclosure.

FIG. 2C is a side schematic view of example solar trackers in a third position with shared agriculture according to an aspect of the present disclosure.

FIG. 3 is a schematic view of inputs to, and outputs of, an example controller 330 configured to control one or more solar trackers, according to an aspect of the present disclosure.

FIG. 4 is an example illustration of an example user interface, according to an aspect of the present disclosure.

FIG. 5 is a flow chart of an example method of operating a solar plant according to an aspect of the present disclosure.

FIG. 6 is a flow chart of an example method of operating a solar plant according to an aspect of the present disclosure.

FIG. 7 is an example graph illustrating a distribution of light between solar trackers and agriculture according to an aspect of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

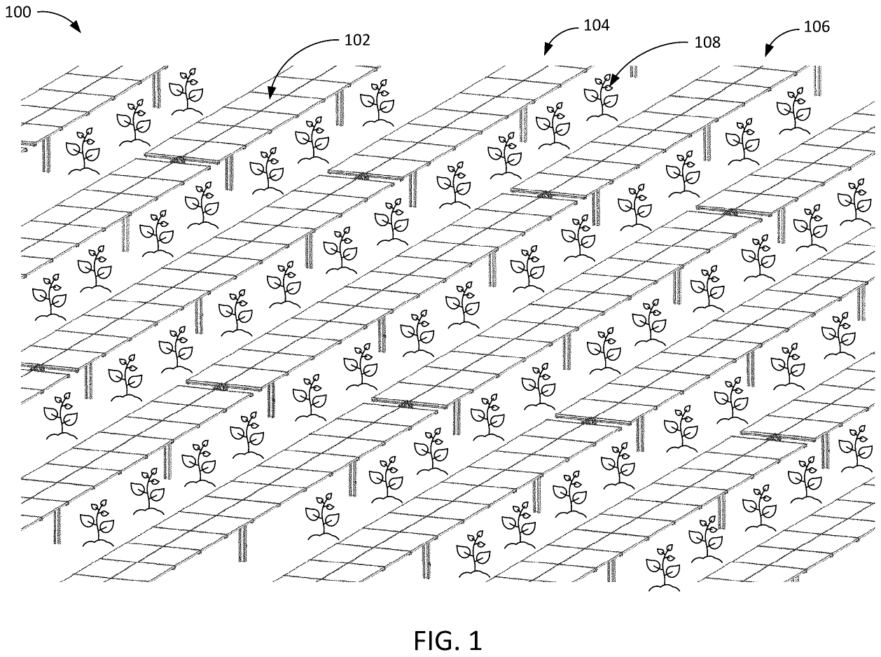

FIG. 1 is a schematic perspective view of an example solar system 100 with shared agriculture according to an aspect of the present disclosure. The solar system 100 includes a plurality of rows of solar trackers 102 including a first row 104 and a second row 106 of solar trackers. The solar trackers can convert solar radiation (e.g., solar irradiance) into electricity with their individual solar modules. Between each of the rows of solar trackers are representations of agriculture. For instance, in the illustrated example, crops 108 are planted in rows between each of the rows of solar trackers 102. Accordingly, the example solar system 100 shares land with the agriculture located between the rows of solar trackers 102.

In the illustrated figure, the solar trackers 102 are single-axis solar trackers comprising individual solar modules. The single-axis solar trackers can be generally aligned in a north-south orientation with the ability to rotate east and west about a central axis defined along the length of each row. With such rotation, the single-axis solar trackers can follow the sun as it travels through the sky, increasing electrical output. In some examples, the solar trackers can be multi-axis solar trackers.

While any type of agriculture can be located between the rows of solar trackers 102, in some examples, crops such as corn, soybeans, barley, oats, and wheat are planted between the rows of solar trackers 102. The illustrated crops 108 are merely representations of agriculture and a person having ordinary skill in the art will appreciate that the number, spacing, and visual representation can vary from the depiction in FIG. 1, depending on the agriculture/crop located between the rows of solar trackers 102.

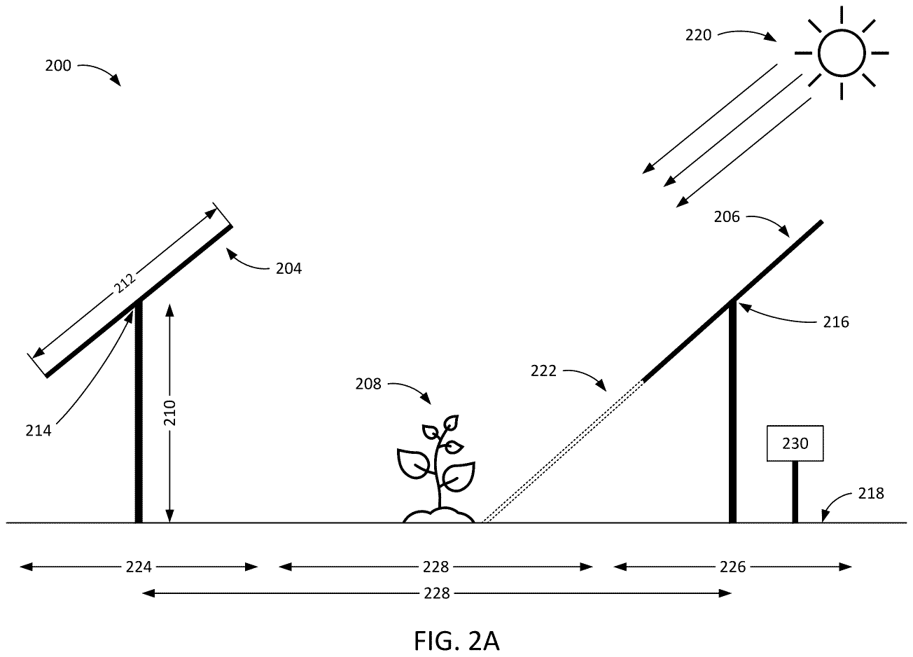

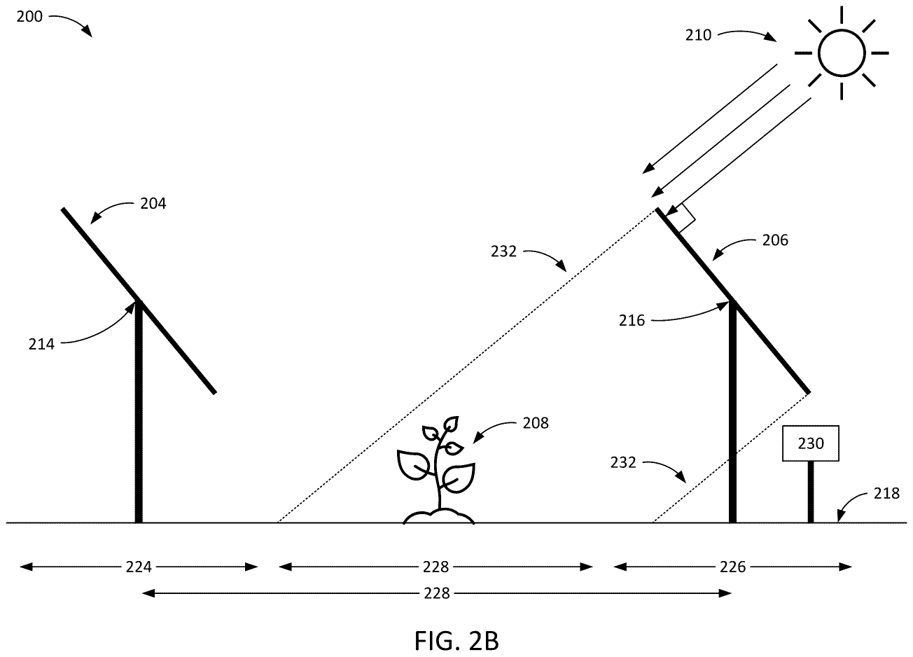

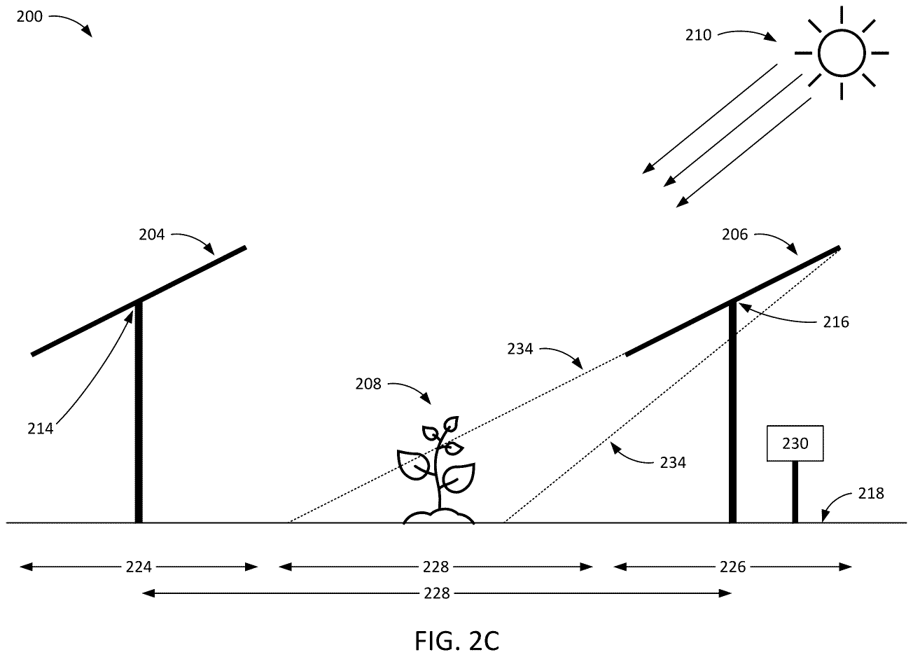

FIG. 2A-2C are side schematic views of example solar trackers in different orientations with shared agriculture according to an aspect of the present disclosure. The solar trackers include a first solar tracker 204 and a second solar tracker 206 with agriculture, in the form of a crop 208, located between them. The angle of the sun is consistent throughout FIG. 2A-2C for illustration purposes. While the angles of the first solar tracker 204 and the second solar tracker 206 are the same as each other in each of the figures, it is not necessary to have the angle of the first solar tracker to be the same as the second solar tracker.

The first and second solar trackers 204, 206 are each connected to one or more motors configured to rotate solar modules of the solar trackers about an axis in order for the solar trackers to track the sun 220. The one or more motors and/or the solar trackers 204, 206 are in communication with one or more controllers 230 and the one or more controllers 230 can control the rotation of the first solar tracker 204 and/or the second solar tracker 206 via the one or more motors. The first solar tracker 204, the second solar tracker 206, and the crop 208 can each represent a row, or multiple rows, of solar trackers or crops planted between rows of solar trackers (e.g., as illustrated in FIG. 1). The solar trackers 204, 206 and the crop 208 are merely for illustration purposes and are not necessarily to scale.

In the example of FIG. 2A-2C, the first solar tracker 204 has a height 210 above the ground 218 and a width 212. The height 210 can correspond with a height of the one or more piers that support the first solar tracker 204. The width 212 can correspond with an amount the solar panels of the first solar tracker 204 extend outwardly from the first axis of rotation 214. The first axis of rotation 214 extends along a length of the first solar tracker (e.g., as is illustrated in FIG. 1) and is located approximately at a top portion of the one more piers supporting the first solar tracker 204. The solar panels of the first solar tracker 204 rotate about the first axis 214 to track the sun, for example. The second solar tracker 206 can similarly have a height above the ground and a width. The second solar tracker 206 also has a second axis of rotation 216 that extends along a length of the second solar tracker (e.g., as illustrated in FIG. 1) and is located approximately at a top portion of the one or more piers supporting the second solar tracker 206. The solar panels of the second solar tracker 204 rotate about the second axis 214 to track the sun, for example. In the illustrated example, the second solar tracker 206 has a height and width that are both substantially similar to the height and width of the first solar tracker 204. However, in some examples, the second solar tracker can have a different width and/or height above the ground 218. For instance, should the ground 218 be uneven (e.g., having different elevations), the height of the second solar tracker relative to the first solar tracker can differ. This can have an impact on shading of one solar tracker on another solar tracker and can further have an impact on control of the first and second solar trackers, as is explained further elsewhere herein.

Multiple regions 224, 226, and 228a, 228b are defined in the illustrated example of FIG. 2A-2C. A first region 224 generally lies below the first solar tracker 204 and can be considered a first tracker band. A second region 226 lies below the second solar tracker 206 and can be considered a second tracker band. Between the first solar tracker 204 and the second solar tracker 206 is a third region 228 which can be considered a managed crop region or “crop region”. The third region 228 can include any extent between the first solar tracker 204 and the second solar tracker 206. For instance, the third region 228 can extend the entirety between the first solar tracker 204 and the second solar tracker 206. The third region 228 can partially overlap one or both of the first region 224 or the second region 226. However, in some examples, the third region 228 can extend between the first region 224 and the second region 226 without overlapping either the first region 224 or the second region 226.

The first region 224 generally extends beneath the first solar tracker 204 and can be defined as the region shaded by the first solar tracker 204 when the sun 220 is directly over the first solar tracker 204 and the first solar tracker 204 is rotated horizontally. Similarly, the second region 226 generally extends beneath the second solar tracker 206 and can be defined as the region shaded by the second solar tracker 206 when the sun 220 is directly over the second solar tracker 206 and the second solar tracker 206 is rotated horizontally. However, the first region 224 and second region 226 can be defined differently. For example, the first and second regions 224, 226 can both be considered regions which are not used in calculating or determining an amount of solar insolation (referred to as “insolation”) received by the third region. The first region 224 and the second region 226 are generally regions that are likely to be shaded by their respective solar trackers for a considerable amount of the day. Accordingly, these regions 224, 226 are not necessarily managed by the control systems and methods disclosed elsewhere herein. In contrast, the third region 228 is a region that can be managed by control systems. Such control systems can provide a desired insolation to the third region and/or the crop 208 located therein and/or can generate a desired amount of electricity by the solar trackers 204, 206, as is disclosed elsewhere herein.

Referring specifically to FIG. 2A, the one or more controllers 230 cause the first and second solar trackers 204, 206 to rotate and have approximately the same angle relative to horizontal as each other. This angle is also approximately the same angle at which the sun's 220 rays hit the first and second solar trackers 204, 206. As illustrated by the dotted lines 222, the second solar tracker 206 will shade a portion of the crop region 228 that is approximately the thickness of the solar modules of the second solar tracker 206. In this configuration, where the solar trackers 204, 206 have an angle relative to horizontal that is approximately equal to the angle at which the sun's 220 rays hit the solar trackers 204, 206, the shaded amount of the crop region 228 is minimized and/or eliminated. Such an angle can maximize the amount of solar energy (i.e., insolation) provided to the crop 208 and minimize and/or eliminate any shading of the crop 208 by the solar trackers 204, 206.

Referring specifically to FIG. 2B, the one or more controllers 230 cause the first and second solar trackers 204, 206 to rotate and have approximately the same angle relative to horizontal as each other. This angle is also approximately perpendicular to the angle at which the sun's 220 rays hit the solar trackers 204, 206. As illustrated by the dotted lines 232, the second solar tracker 206 will shade a portion of the crop region 228. The shade of the second solar tracker 206 is a projection of the width (e.g., 212) of the second solar tracker 206 upon the ground 218 at the given angle of the sun and the angle of the second solar tracker 206. In some examples, the second solar tracker 206 shades the entirety of the crop region 228. In the configuration of FIG. 2B, where the solar trackers 204, 206 have an angle relative to horizontal that is approximately perpendicular to the angle at which the sun's 220 rays hit the solar trackers 204, 206, the shaded amount of the crop region 228 is not minimized and can, in some examples, be maximized. Such an angle can maximize the amount of solar energy (i.e., insolation) provided to the solar trackers 204, 206 and can minimize any shading of the solar trackers 204, 206 (e.g., by each other). As a consequence, the solar energy (i.e., insolation) provided to the crop 208 can be minimized.

Referring specifically to FIG. 2C, the one or more controllers 230 cause the first and second solar trackers 204, 206 to rotate and have approximately the same angle relative to horizontal as each other. This angle is also approximately between the angles illustrated in FIG. 2A and FIG. 2B. As illustrated by the dotted lines 234, the second solar tracker 206 will shade a portion of the crop region 228. The shade of the second solar tracker 206 is a projection of the width (e.g., 212) of the second solar tracker 206 upon the ground 218 at the given angle of the sun and the angle of the second solar tracker 206. In the configuration of FIG. 2C, the angle of the second solar tracker causes partial shading of the crop 208, but is an angle at which the solar trackers 204, 206 receive more of the sun's energy (i.e., insolation) than the angle of the solar trackers 204, 206 illustrated in FIG. 2A. In other words, the angle of the solar trackers of FIG. 2C lies between the angles of the solar trackers illustrated in FIG. 2A and FIG. 2B. Having the solar tracker 204, 206 of FIG. 2B at the illustrated angle can provide a compromise between maximizing insolation provided to the solar trackers 204, 206 and maximizing insolation provided to the crop 208.

Referring collectively to FIG. 2A-2C, the first solar tracker 204 and the second solar tracker 206 are controlled by the one or more controllers 230 to rotate about their respective axes using one or more motors. Throughout this disclosure, when referring to “a/the controller” or “one or more controllers”, it will be understood that any number of controllers can be used and that the controller(s) can be configured to perform the described action. Further, the term “controller” is to be given its broadest reasonable interpretation that at least encompasses a processor in communication with a memory storing instructions that, when executed by the processor, cause the processor to perform a described function.

The one or more controllers 230 can be in different configurations, such as a distributed controller configuration, a central controller configuration, or some combination of the two. For instance, in some examples, a controller can be used for each motor of the solar system, with each motor and controller causing one or more connected solar trackers to rotate. Each of these controllers can be in communication with each other and/or with a coordinating controller that can send and receive communications (e.g., commands, data) to the controllers. In some examples, a network control unit (NCU) can communicate with multiple controllers (e.g., “self-powered controllers”) with each network control unit connected to a network that can receive inputs (e.g., from a user, from a more central controller). A person having ordinary skill in the art will appreciate that control schemes other than those described are contemplated and that this disclosure is not limited to the examples of the controller 230.

Further in FIG. 2A-2C, the controller 230 is configured to cause the first solar tracker 204 and/or the second solar tracker 206 to rotate such that an amount of insolation is split between being received by the solar trackers 204, 206 and being received by the crop. While the term “insolation” is used, it is not limiting. For instance, the term “amount of light” or simply “light” can be used in place of the term insolation with the recognition that they are not equivalent terms, but can correspond to each other. The systems and methods described herein are applicable to both terms. When insolation (or light) is received by the solar trackers 204, 206, the solar trackers 204, 206 can generate electricity. When insolation is received by the crop 208, the crop 208 can grow. Other effects of splitting insolation are described elsewhere herein. In general, a controller can split insolation between being received by solar trackers and being received by crops with the split being based on and/or determined by one or more inputs.

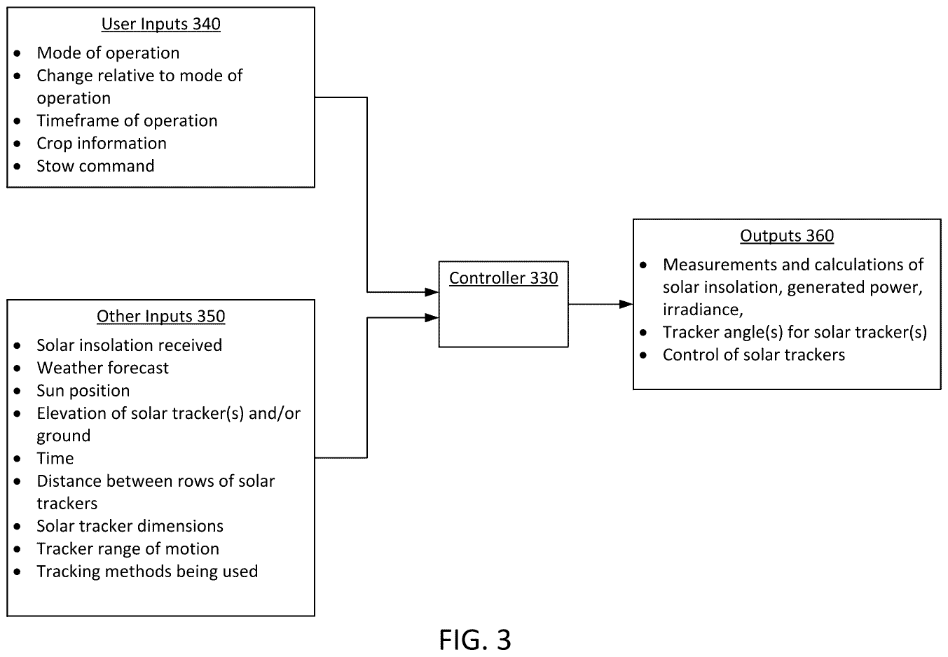

FIG. 3 is a schematic view of inputs to, and outputs of, an example controller 330 configured to control one or more solar trackers, according to an aspect of the present disclosure. The one or more controllers 230 of FIG. 2A-2C can be embodiments of the example controller 330 of FIG. 3. In the illustrated embodiment, FIG. 3 includes both user inputs 340 and other inputs 350 along with the outputs 360 of the controller 330. The user inputs 340 include inputs that are typically controlled/input by a user while the other inputs 350 include inputs that are typically not controlled by the user. However, in some examples, the other inputs 350 include inputs that are controllable by a user and in some examples, one or more of the user inputs 340 may not be controllable by a user. In general, the user inputs 340 and the other inputs 350 are used by the controller 330 to generate the outputs 360, which include a control operation of the one or more solar trackers whereby angles of the solar trackers are set and/or adjusted.

The user inputs 340 to the controller 330 include a mode of operation, a change relative to the mode of operation, a timeframe for operation, crop information, and a stow command, for selected solar trackers. The user inputs 340 can be input to the controller 330 using a variety of methods. For example, the user inputs 340 can be input by a user into a user interface that is displayed. In some examples, the user inputs 340 are input to a user device that communicates the user inputs 340 to the controller 330 (e.g., via a network).

Referring to the user input of a mode of operation, a user can select (e.g., via a user interface) a mode of operation from a list of modes that include PV optimal, maximum light, uniform light, and thermal optimal modes of operation. In these modes of operation, the controller 330 can communicate with solar trackers to cause the solar trackers to rotate to achieve the desired effect. The modes of operation can be applied to any number of solar trackers of a solar tracker system. In most cases, a user can only select one of the modes of operation at a time to apply to a number of solar trackers. However, different modes of operation can be applied to different solar trackers within an overall solar tracker system. Other modes of operation are contemplated, including combinations of modes, and modes can be applied at any time to any number of solar trackers.

In the PV optimal mode, the controller 330 will default to maximizing the energy output of the solar trackers (e.g., 204, 206), which generally includes maximizing insolation received by the solar trackers. To maximize the energy output of the solar trackers, the controller 330 causes the solar trackers to rotate to angles that enable the solar trackers to generate maximum energy for the given conditions. For instance, in sunny conditions, the controller 330 can cause the solar trackers to track the sun such that light from the sun strikes the solar modules of the solar trackers at a perpendicular, or near-perpendicular, angle (e.g., as illustrated in FIG. 2B). However, in cloudy or diffuse light conditions, to maximize the energy output of the solar trackers, the controller 330 may cause the solar trackers to rotate to other angles that are not perpendicular to where light from the sun would strike the solar modules of the solar trackers. Further, the controller 330 may cause the solar trackers to rotate to angles that limit shading of other solar trackers (e.g., backtracking).

In the maximum light mode, the controller 330 will default to maximizing the amount of insolation received by a crop (e.g., 208). Throughout this disclosure, while the term “crop” is used, the term “crop region” can be used in place of the term “crop” and vice versa despite it being recognized that these are not equivalent terms. The systems and methods described herein are applicable to both terms. To maximize the amount of insolation received by the crop, the controller 330 causes the solar trackers to rotate to angles that enable the crop to receive the maximum insolation for the given conditions. For instance, in sunny conditions, the controller 330 causes the solar trackers to minimize an amount of shade cast by the solar trackers upon the crop or upon the ground in the crop region (e.g., as illustrated in FIG. 2A). In cloudy or diffuse light conditions, the controller 330 may cause the solar trackers to rotate to other angles. For instance, the controller 330 can cause the solar trackers to rotate to angles that cause an increase in incident light upon the crops or crop region.

In the uniform light mode, the controller 330 will default to causing the crop and/or crop region to receive approximately the same amount of light, or the same amount of insolation, throughout a period of time. While the term “light” is used, the term “insolation” can be used in place of the term “light” even though it is recognized they are not entirely equivalent in meaning. The amount of light, along with the period of time, can be defined. For example, a user can define the amount of light for a desired timeframe via a user input 340, as is discussed elsewhere herein. To achieve uniform light, the controller 330 causes the solar trackers to rotate to angles that enable the crop and/or the crop region to receive the same amount of light for a given time. For example, the controller 330 can cause the solar trackers to track the sun at an offset to the PV optimal mode such that the offset causes the same amount of light to reach the crop/crop region. The offset can change depending upon the time of day with a larger offset during times of lower light and a smaller offset during times of greater light. For instance, in sunny conditions, the controller 330 causes the solar trackers to track the sun with an offset such that the angles of the solar trackers lie between the angle(s) for the PV optimal mode and the angle(s) for the maximum light mode (e.g., as illustrated in FIG. 2C). The crop/crop region can be partially sunny and partially shaded. In some examples, the controller 330 causes the solar trackers to rotate approximately continuously (e.g., a change of angle every zero to five minutes) to ensure a uniform amount of light is received by the crop/crop region. Additionally or alternatively, in some examples, the controller 330 causes the solar trackers to rotate at various time intervals to ensure a uniform amount of light is received by the crop/crop region.

In the thermal optimal mode, the controller 330 will operate the solar trackers to cause the crop (e.g., 208) and/or crop region (e.g., 228) to receive a set amount of thermal energy from the sun, which can be for a given time. In some examples, to achieve the set amount of thermal energy, the controller 330 can cause the solar trackers to rotate between angles that maximize the energy output of the solar trackers for the given conditions (e.g., as illustrated in FIG. 2B) and angles that maximize the amount of light and/or insolation received by the crop and/or crop region (e.g., as illustrated in FIG. 2A). Accordingly, insolation, which includes heat energy, is received by the crop and/or crop region when the solar trackers are rotating to, or rotated at, the angles that maximize the amount of light received by the crop and/or crop region. For example, the controller 330 can cause the solar trackers to rotate to angles that maximize the amount of light and/or insolation during a first period, subsequently cause the solar trackers to rotate to angles that maximize the energy output of the solar trackers, and optionally again cause the solar trackers to rotate to angles that maximize the amount of light and/or insolation during a second period. In some examples, though, the controller 330 can cause the solar trackers to rotate to angles that maximize the energy output of the solar trackers for the given conditions (e.g., as illustrated in FIG. 2B), and then, for a period of time, stop rotating. The controller 330 can repeat these steps of causing the solar trackers to rotate to angles that maximize the energy output of the solar trackers for the given conditions and stop rotating the solar trackers for a period of time. Accordingly, insolation, which includes heat energy, is received by the crop and/or crop region for the period of time when the solar trackers are not rotating.

In addition to or in the alternative to the thermal optimal mode, a second thermal optimal mode is contemplated. In operation of the second thermal optimal mode, the controller 330 can control the solar trackers to shade the crop and/or crop region during peak times of heat, such as when the air temperature with the addition of solar radiation could damage a crop. In such an operation, the controller 330 can control the angle of the solar trackers for the shading, which can be partial shading (e.g., as illustrated in FIG. 2C). The second thermal optimal mode can also include an operation where the controller 330 can control the solar trackers to prevent heat loss from the ground into the air, such as when an overnight air temperature could cause frost on the crop. In such an operation, the controller 330 can control the angle of the solar trackers to be substantially horizontal to prevent heat loss from the ground and the associated crops. These operations of the second thermal optimal mode can be used in addition to and/or in conjunction with other modes. For instance, the controller 330 can operate in a uniform light mode for most of a day and subsequently operate in a second thermal optimal mode to prevent overnight heat loss.

A water management mode is also contemplated. In operation of a water management mode, the controller 330 can control the solar trackers to increase shading of the crop and/or crop region for a desired amount of time. By increasing shading of the crop and/or crop region, an amount of evaporation (e.g., due to solar heating/radiation) of the crop and/or of the soil can be decreased. In some examples, the controller 330 can control the angle of the solar trackers to shade the crop and/or crop region during periods of low moisture/drought. Some of the angles of the solar trackers may corresponding to angles of PV optimal operation, such as for the sun position illustrated in FIG. 2B, whereby the solar trackers can completely shade the crop and/or crop region. However, other angles for shading the crop and/or crop region may not be optimal for PV generation. In some examples, operation of the water management mode maximizes shade on the crop and/or crop region to maximize water retention within the crop and/or corresponding soil. As with other modes of operation, the solar trackers in the water management mode can rotate continuously and/or at intervals to shade the crop and/or crop region. In diffuse weather conditions, solar trackers in the water management mode can be rotated in a different manner than when the solar trackers are in sunny weather conditions.

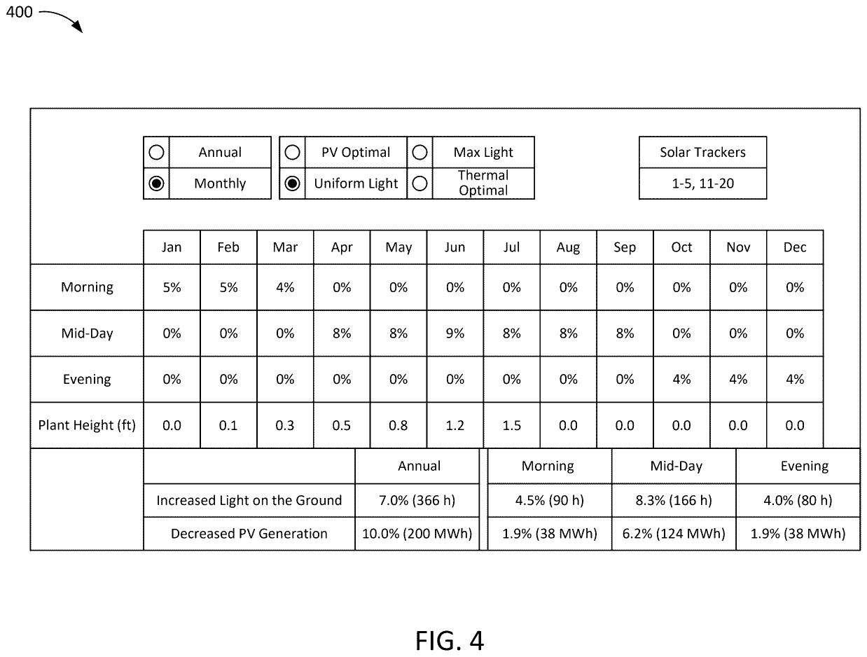

Each of the modes described herein can be modified by further user inputs, which include the change relative to the mode of operation, the timeframe of operation, crop information, and a stow command. An example user interface is illustrated in FIG. 4 with user inputs shown for a particular example. The particular instance illustrated in FIG. 4 includes arbitrary values for explanation purposes.

Referring to FIG. 3 and FIG. 4, the change relative to the mode of operation is an adjustment and/or input to the default operation of the selected mode. The change relative to the mode of operation can be specific to a period of time and can be specified in a percentage. While certain periods and timeframes are described, the periods and timeframes are not limited to the examples provided and can comprise any amount of time.

For example, a user can select the uniform light mode, which defaults to causing the crop and/or crop region to receive approximately the same amount of light and/or insolation throughout a period of time. The user can then input a percentage that corresponds to a desired amount of light/insolation out of the maximum light/insolation receivable by the crop and/or crop region during the period of time. In the example of FIG. 4, a user input of 5% during the mornings (e.g., 6 am-10 am) of the month of January corresponds to providing uniform light to a crop and/or crop region during the entire morning period such that 5% of the maximum light/insolation receivable by the crop and/or crop region during the entire morning period is provided to the crop and/or crop region. For instance, should the maximum receivable insolation during the period of 6 am- 10 am be 1800 Wh/m², the controller 330 will control the solar trackers to cause 90 Wh/m² to be received by the crop and/or crop region during the period of 6 am-10 am in an approximately uniform manner (e.g., 22.5 Wh/m² per hour).

In another example, a user can select the PV optimal mode, which defaults to maximizing light/insolation received by the solar trackers. The user can then input a percentage that corresponds to a desired amount of time during which the controller 330 controls the solar trackers to rotate to maximize light/insolation on a crop/crop region. For instance, a user input of 5% during the mornings (e.g., 6 am-10 am) of the month of January corresponds to providing a maximum amount of light/insolation to a crop/crop region for 12 minutes of the 4-hour timeframe and maximizing the energy output of the solar trackers for the other 3 hours and 48 minutes. The exact timeframe of the 12 minutes during which the solar trackers are controlled to maximize light/insolation on the crop/crop region is not limited and can be during any period of the 4-hour timeframe. In some examples, the controller 330 will cause the solar trackers to rotate to maximize light/insolation on the crop/crop region during a period that requires the least amount of rotation from the angles corresponding to maximizing the energy output of the solar trackers. For instance, the timeframe for maximizing the light/insolation on the crop/crop region can be the first stretch of time during the selected window of time, e.g., the first 12 minutes of the 4-hour morning timeframe during the selected month. In another instance, the timeframe for maximizing the light/insolation on the crop/crop region can be the last stretch of time during the selected window of time, e.g., the last 12 minutes of a 4-hour evening timeframe during the selected month.

In another example, a user can select the maximum light mode, which defaults to maximizing light/insolation received by the crop/crop region. In such a mode, the operation can be the inverse of the PV optimal mode. For instance, a user input of 5% during the mornings (e.g., 6 am-10 am) of the month of January corresponds to maximizing the energy output of the solar trackers for 12 minutes of the 4-hour timeframe and providing a maximum amount of light/insolation to a crop region for the other 3 hours and 48 minutes. The exact timeframe of the 12 minutes during which the solar trackers are controlled to maximize the energy output of the solar trackers is not limited and can be any period of the 4-hour timeframe. In some examples, the controller 330 will cause the solar trackers to rotate to maximize the energy output of the solar trackers during a period that requires the least amount of rotation from the angles corresponding to maximizing the light/insolation on the crop/crop region. In some examples, the controller 330 will cause the solar trackers to rotate to maximize the energy output of the solar trackers during a period that is likely to generate the most amount of energy, e.g., when the insolation is the highest during the timeframe.

In another example, a user can select the thermal optimal mode, which causes the crop/crop region to receive a set amount of thermal energy from the sun for a period of time. The user can input the set amount of thermal energy by providing a percentage that corresponds to a desired amount of thermal energy received by the crop/crop region during a period of time. For example, a user input of 5% during the mornings (e.g., 6 am-10 am) of the month of January can correspond to a 5% duty cycle, whereby the solar trackers are rotated to maximize thermal energy and/or light/insolation on a crop/crop region for 5% of the 4-hour timeframe (e.g., 12 minutes) and are rotated to maximize energy output the other 95% of the 4-hour timeframe (e.g., 3 hours 48 minutes). In some examples, the 5% of time can be discontinuous (e.g., six periods of 2 minutes each, for a total of 12 minutes). In some examples, the 5% of time can be continuous (e.g., 12 continuous minutes).

Continuing to refer to FIG. 3 and FIG. 4, the modes of operation described herein can be modified by a user input of a timeframe of operation. For example, a user can select an annual or monthly input, with an instance of the monthly input being illustrated in FIG. 4. The monthly input can enable a user to input different inputs of change (e.g., percentages) relative to the mode of operation for each month. In comparison, the annual input can enable a user to input different inputs of change (e.g., percentages) relative to the mode of operation for the entire year. For both the annual and monthly inputs, though, different times of day may be included for a user to input changes relative to the mode of operation. For instance, the morning, mid-day, and evening periods illustrated in FIG. 4 can be used for each month, in the case of a user selecting the monthly timeframe, or can be used for the entire year, in the case of a user selecting the annual timeframe. The user input of a timeframe of operation can provide a user with a more granular, or a less granular, ability to change the mode of operation (e.g. via inputs of percentages).

A user can also input crop information. The crop information can include various aspects of the crop/crop region, including but not limited to a crop height and a type of crop. The crop information can be used by a controller 330 in order for the controller 330 to operate according to the other inputs provided. For example, as illustrated in FIG. 4, a crop height can be input in terms of feet for a given month, such as 1.2 feet in the month of June. The height of the crop can affect how the solar trackers shade the crop and accordingly, the angles of the solar trackers may be adjusted to account for this difference in shading. In some examples, as the crop height increases, a controller 330 can effectuate change of the angles of the solar trackers in a selected mode of operation such that the solar trackers are angled to generate more energy. A relatively low crop height can correspond to the solar trackers being angled more toward an angle that maximizes light/insolation on the crop to avoid shading, while a relatively high crop height can correspond to the solar trackers being able to be angled more toward an angle that maximizes energy generation of the solar trackers while still avoiding shading. In addition to or in lieu of the crop height, a crop type can be used to effectuate similar adjustments to solar trackers to operate according to a selected mode of operation. For instance, if a crop is selected to be corn, which grows relatively tall, the controller 330 can cause a change of the angles of the solar trackers to compensate for the height or predicted height of the corn (e.g., to avoid shading the corn).

A user can also input a stow command. A stow command corresponds to changing the angles of the solar trackers to a stow angle, which can be a maximum rotation to either direction (e.g., +60 degrees or −60 degrees relative to horizontal) and/or a horizontal alignment (e.g., 0 degrees relative to horizontal). The stow command can include a user input for an amount of time for stowing the solar trackers. Including a stow input can enable a user to perform various tasks related to the crop with minimal interference from the solar trackers. For example, a user can input a stow command when harvesting the crops. Once harvested, the solar trackers can return to their selected mode of operation (e.g., PV optimal).

A user can also select which solar trackers the inputs apply to and to which the associated outputs will also apply. The selected solar trackers can be selected in any manner, but in some examples, are selected based on rows, based on which solar trackers are connected to a controller (e.g., a network control unit), or based on solar modules that are connected to an individual motor (i.e., by individual solar trackers).

In addition to the described user inputs, the other inputs 350 can be used by the controller 330 to generate the outputs 360, including a control operation of the solar trackers to set/adjust angles of the solar trackers. These other inputs can include external inputs, non-end use inputs, intrinsic inputs, etc.

For instance, the other inputs 350 can include measurements and/or calculations of light and/or insolation. The measurements and/or calculations of light/insolation can be specific to a particular area, which can include light/insolation received by the solar trackers, insolation/light received by the crop/crop region, insolation/light of a combination of both, etc. The measurements can be taken by any device, such as by a pyranometer or a reference solar panel, etc. and can be obtained by any method. The measurements can be current measurements, calculated values, and/or predicted values. Other than direct measurements, the values of light/insolation can be determined using data that can also be a part of the other inputs 350. For example, weather forecasts, sun positions, ground elevations, times associated with the forecasts and sun positions, distances between rows of solar trackers, solar tracker dimensions, solar trackers range of motion, tracking methods being used etc. can each be used to measure and/or determine light/insolation. In some examples, the measured and/or determined light/insolation is specific to a subset of solar trackers (e.g., a row of solar trackers, solar trackers that are in close proximity with each other).

In addition to the measured, calculated, and/or predicted insolation, the other inputs of weather forecasts (e.g., sunny, cloudy, temperatures), sun positions (e.g., based on latitude, longitude), ground elevations (e.g., relative to sea level), elevations of solar trackers (e.g., elevation of one row of solar trackers relative to another row of solar tracker), times associated with the forecasts and sun positions, distances between rows of solar trackers, solar tracker dimensions (e.g., height of pier, height width and length of solar module), solar trackers range of motion (e.g., maximum rotation in either direction including being limited by a user input of plant height), tracking methods being used (e.g., backtracking) etc. can also be used by the controller 330 for the outputs 360. Each of these factors can be used by the controller 330 in its determinations/calculations of the angles for operating the solar trackers for a given mode of operation (e.g., for a PV optimal mode, a uniform light mode, a maximum light mode, a thermal optimal mode). A person having ordinary skill in the art will appreciate how each of these factors can be used by the controller in its determinations/calculations of the angles for operating the solar trackers for a given mode of operation. However, the following examples discuss some of the ways in which these factors can affect the controller's determinations/calculations of the angles for operating the solar trackers for a given mode of operation.

The controller can use a weather forecast that predicts cloudy/diffuse weather to adjust angles of the solar trackers to maximize energy production as the solar trackers are unlikely to shade a crop/crop region. The controller can use a sun position of being directly overhead in its determination to maximize energy production as the solar trackers are unlikely to shade a crop/crop region. The controller can use a ground elevation, which relates to where the crop is located relative to the solar trackers, to determine that the solar trackers may shade a crop/crop region during some times of day and not others. The controller can use elevations of the solar trackers, such as the elevations of the solar trackers relative to each other (e.g., between rows) to determine how the solar trackers may shade a crop/crop region and/or shade each other. The controller can use distances between rows of various solar trackers, and relative distances between the crops and the solar trackers, both of which may not be uniform, to determine how the solar trackers may shade a crop/crop region. Similarly, the controller can use the dimensions of the solar trackers to determine how the solar trackers may shade a crop/crop region. The controller can also use the solar tracker's range of motion, which can be limited (e.g., to +60 degrees and −60 degrees relative to horizontal), to determine when to maximize energy generated by the solar trackers or at what angle to stow the solar trackers. The controller can use the tracking methods being used, such as a backtracking, to determine that the solar trackers should rotate in a different direction that minimizes shading of other solar trackers to maximize overall energy production.

The controller 330 also provides the outputs 360. The primary output of the controller 330 is used to control operation of the solar trackers, in particular, to control the angles at which the solar trackers are rotated. The output to control the solar trackers can be direct or indirect. For example, the controller 330 can send signals directly to motors that actuate rotation of the solar trackers and/or can send signals indirectly to intermediate devices that eventually leads to rotation of the motors that actuate the rotation of the solar trackers. Other outputs can include measurements, calculations, graphs, display outputs etc. of insolation, irradiance, generated power, values of the inputs etc.

For example, as illustrated in the user interface of FIG. 4, the controller 330 can output a calculated amount of increased light on the ground and a decreased PV generation from the given user inputs 340, such as the selected uniform light mode, the monthly timeframe, the input percentages, and the plant height, along with the other inputs 350 which are not displayed. In the particular example, given the user inputs 340 of the uniform light mode, the various percentages and crop heights for the given months and periods of time (i.e., morning, mid-day, evening), the designated solar trackers, and given the other inputs that are not specified by the user, an annual increase of light/insolation on the ground/crop/crop region relative to a maximum energy production by the solar trackers is approximately 7.0% or 366 hours (h). This increase of light/insolation is broken down based on the amount of increase during the morning (e.g., 90 h), the mid-day (e.g., 166 h), and the evening (e.g., 80 h)time periods. Additionally, the associated decrease in PV energy generation is larger at approximately 10.0% or 200MWh. This decrease is also broken based on the amount of decrease during the morning (e.g., 38 MWh), the mid-day (e.g., 124 MWh), and the evening (e.g., 38 MWh) time periods.

While a particular user interface is illustrated in the example of FIG. 4, other user interfaces are contemplated. For instance, a user interface can include less granular inputs, which can correspond to a controller performing more operations automatically rather than as dictated by a user (e.g. via the inputs illustrated in FIG. 4). In some examples, a user interface can be configured to enable a user to input a total amount of insolation for a specified duration (e.g., 1 week, 1 month), rather than a percentage as in FIG. 4. A controller (e.g., controller 330) or processor in communication with the controller can then automatically determine and plan how much light should be on the ground for various time periods throughout the day, and throughout the specified duration. Such a determination can change over time depending on inputs, such as one or more of the other inputs 350. The controller 330 can then cause the solar trackers to rotate to achieve the desired amount of insolation while taking into account the one or more of the other inputs, 350 such as weather. For instance, in one such example, should a user input a desired total amount of insolation to be on a crop and/or crop region over the month of June, the controller can determine how much time the solar trackers need to be rotated away from PV optimal angles (e.g., that generate a maximum amount of electricity). Further, should the weather during the first few weeks of June include more diffuse conditions (e.g., cloudy weather), the controller can determine that in order to make up for the deficit of solar insolation on the crop and/or crop region, the controller will need to adjust the angles of the solar trackers to be closer to the angles associated with maximum light on the crop and/or crop region operation. In an opposite example, should the weather during the first few weeks of June include more sunny conditions, the controller can increase shading of the crop and/or crop region accordingly by rotating the solar trackers to angles that achieve the desired outcome. As a person having ordinary skill in the art will appreciate, the controller can weigh various inputs to optimize the angles of the solar trackers to achieve the desired amount of insolation for the specified duration, as input by a user.

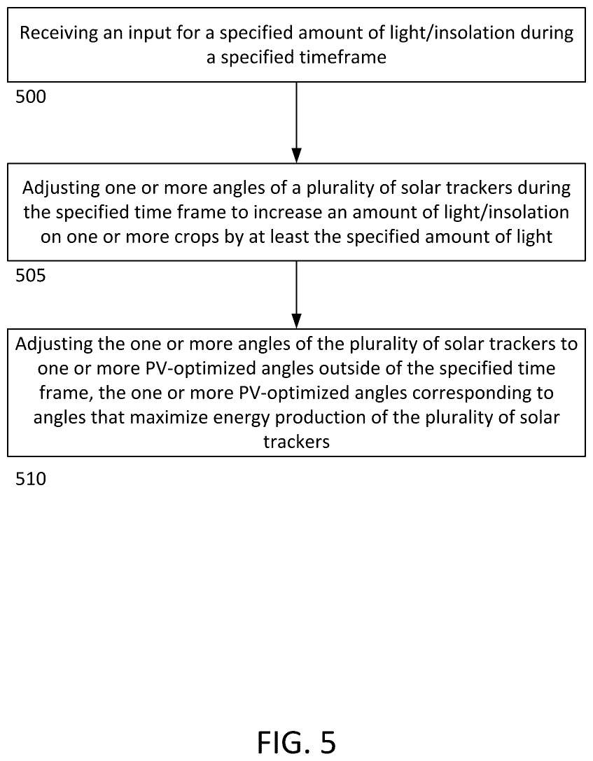

FIG. 5 is a flow chart of an example method of operating a solar plant according to an aspect of the present disclosure. The solar plant of the example method includes a plurality of solar tracker with each of the plurality of solar trackers being located proximate to one or more crops planted in the ground and being configured to selectively shade the one or more crops. Flow of the method starts at 500 with receiving an input for a specified amount of light/insolation during a specified timeframe. As discussed elsewhere herein, the specified amount of light/insolation can be from a user input, such as an input of 5%, for a given mode of operation, and the specified timeframe can be a time of day, such as morning, mid-day, or evening for a given month or annually. Flow continues at 505 with adjusting one or more angles of the plurality of solar trackers during the specified time frame to increase an amount of light/insolation on the one or more crops by at least the specified amount of light. For example, increasing the amount of light/insolation on a crop by 5% of the maximum light/insolation usable by solar trackers when they are angled to maximize energy generation. Flow continues with 510 with adjusting the one or more angles of the plurality of solar trackers to one or more PV-optimized angles outside of the specified time frame with the one or more PV-optimized angles corresponding to angles that maximize energy production of the plurality of solar trackers.

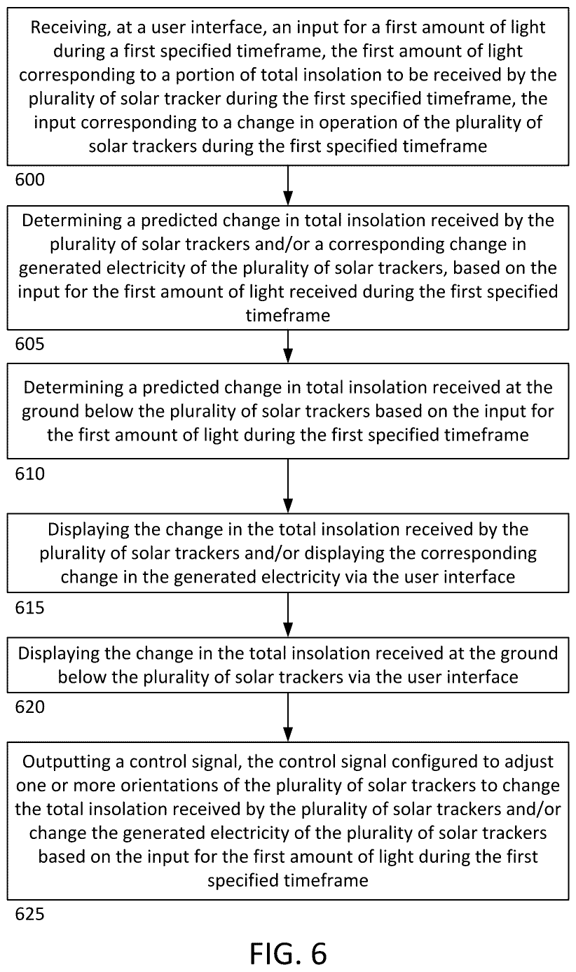

FIG. 6 is a flow chart of an example method of operating a solar plant according to an aspect of the present disclosure. Flow of the method starts at 600 with receiving, at a user interface, an input for a first amount of light during a first specified timeframe. The first amount of light can correspond to a portion of total solar insolation to be received by the plurality of solar trackers during the first specified timeframe and the input can correspond to a change in operation of the plurality of solar trackers during the first specified timeframe. Flow continues with 605, with determining a predicted change in total insolation received by the plurality of solar trackers and/or a corresponding change in generated electricity of the plurality of solar trackers, based on the input for the first amount of light received during the first specified timeframe. The predicted change can be calculated, for example, by a controller, as is described elsewhere herein. Flow continues at 610 with determining a predicted change in total insolation received at the ground below the plurality of solar trackers based on the input for the first amount of light during the first specified timeframe. The predicted change in total insolation received at the ground below the plurality of solar trackers can include the predicted change in total insolation received by a crop and/or by a crop region, as is described elsewhere herein. Flow further continues at 615 with displaying the change in the total insolation received by the plurality of solar trackers and/or displaying the corresponding change in the generated electricity via the user interface (for example, as illustrated in FIG. 4). Flow then continues at 620 with displaying the change in the total insolation received at the ground below the plurality of solar trackers via the user interface (for example, as illustrated in FIG. 4). Flow further continues at 625 with outputting a control signal. The control signal is configured to adjust one or more orientations of the plurality of solar trackers to change the total insolation received by the plurality of solar trackers and/or change the generated electricity generated by the plurality of solar trackers, and is based on the input for the first amount of light during the first specified timeframe. For example, as discussed elsewhere herein, a user can select a mode and input values into the user interface illustrated in FIG. 4, which can eventually cause a controller to output a control signal to cause a plurality of solar trackers to rotate to achieve the desired operation that is based on the user's inputs.

Although the examples of the methods illustrated in FIG. 5 and FIG. 6 show particular sequences of operations, the sequences may be altered without departing from the scope of the present disclosure. For example, some of the operations depicted may be performed in parallel or in a different sequence that does not materially affect the function of the illustrated methods. In other examples, different components of example devices or systems that can implement these methods may perform functions at substantially the same time or in specific sequences.

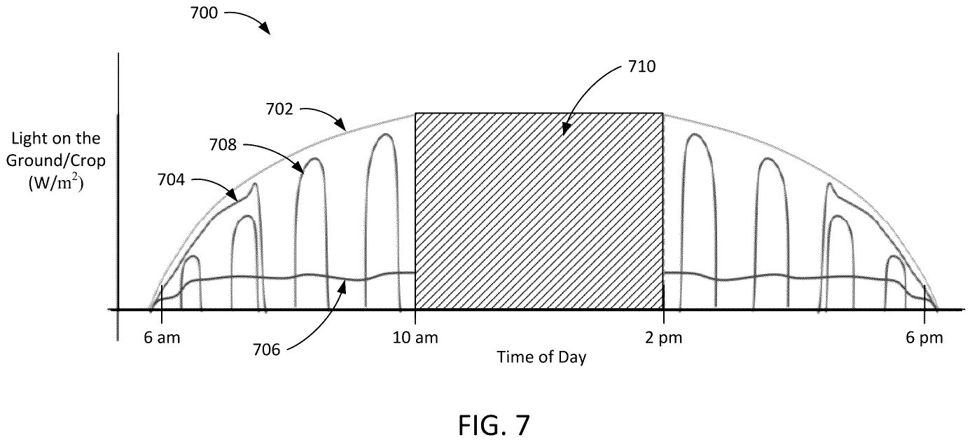

FIG. 7 is an example graph 700 illustrating a distribution of light between solar trackers and agriculture according to an aspect of the present disclosure. In particular, FIG. 7 illustrates the distributions of light between solar trackers and a crop over the course of an example day depending on a mode of operation, including a maximum light mode 702, a PV optimal mode 704, a uniform light mode 706, and thermal optimal mode 708 of operation, each of which is described elsewhere herein. Each curve illustrates a different mode of operation of the solar trackers. The y-axis represents a light on the ground and/or crop, which can have units of watts per meter squared (W/m²), while the x-axis represents a time of day. The y-axis does not start at zero, but generally represents an amount of light available on the ground/crop with typical or standard tracking methodologies. The graph of FIG. 7 is a theoretical example illustrating the distribution of light between solar trackers and agriculture on a cloudless day and with other factors of solar trackers and agriculture matched to compare the different modes of operation of the solar trackers. A person having ordinary skill in the art will appreciate that each of the lines illustrating a mode of operation of the solar trackers is an approximation and that this disclosure is not limited to the illustrated comparative lines of light on the ground/crop vs. time for the different modes of operation.

Starting with a maximum light mode 702, the maximum light mode 702 comprises the topmost line in the graph of FIG. 7 and represents where a controller can cause solar trackers to rotate to angle that enable the ground/crop to receive maximum insolation (e.g., as illustrated in FIG. 2A). As the amount of solar insolation rises over time, the amount of solar insolation (e.g., light) received on the ground also increases, such as in the period from 6 am to 10 am. However, due to various factors including the angle of the sun relative to the solar trackers during the mid-day hours (e.g., between 10 am and 2 pm) and the maximum rotation of the solar trackers, the amount of light on the ground/crop is not necessarily manageable during the mid-day hours as represented by the region 710. The exact amount of insolation received during this timeframe is dependent upon many factors including the geographical location of the crop, the height of the crop, the height of the solar trackers, the width of the solar trackers, the distance between the rows of the solar trackers, and the like. After the mid-day hours, though, the solar trackers operating according to the maximum light mode can again effectively manage the amount of light on the ground/crop. As illustrated, the amount of light on the ground/crop is again maximized for the afternoon timeframe (e.g., 2 pm to 6 pm) until the sun sets. A person having ordinary skill in the art will appreciate that the timings provided for the region 710 are not limiting and can encompass other timings.

The example of FIG. 7 also illustrates a PV optimal mode 704. As described elsewhere herein, the PV optimal mode is a mode including a user input for a specified amount of light on the ground/crop. The PV optimal mode 704 illustrated in FIG. 7 comprises the line just below the maximum light mode line, and which quickly drops off around mid-morning (e.g., 8 am). In such a mode, a user can input a specified amount of light on the ground/crop that is desired in for a given time (e.g., 5% of the light available during the morning hours 6 am to 10 am and 5% of the light available during the evening hours of 2 pm to 6 pm). A controller can then control the solar trackers to rotate such that the given amount of light is received by the ground/crop during the given time. However, upon the specified amount of light being received, the controller can return the solar trackers to track the sun with maximum efficiency, i.e., maximize solar insolation received by the solar trackers. In the illustrated example, the solar trackers maximize (or nearly maximize) an amount of light on the ground/crop during the morning hours (e.g., 6 am to 8 am) and thus the line 704 generally follows the maximum light mode line 702. But, at approximately 8 am, the specified amount of light on the ground/crop is reached and the solar trackers quickly resume tracking the sun with maximum efficiency. Accordingly, the PV optimal line 704 sharply decreases to at or below the y-axis representing typical or standard tracking methodologies. Given that a user also desires a specific amount of light on the ground/crop in the afternoon hours (e.g., 2 pm to 6 pm), later in the day (e.g., 4 pm), the solar trackers can again maximize (or nearly maximize) an amount of light on the ground/crop and thus the PV optimal mode line 704 sharply increases toward the maximum light mode line until the sun sets (e.g., around 6 pm). As on having ordinary skill in the art will appreciate, the times during which the PV optimal mode 704 closely follow the maximum light mode 702 can vary and are not limited to the illustrated example of FIG. 7. For instance, the PV optimal mode line could sharply increase at around 8 am, follow the maximum light mode line until 10 am, and then sharply decrease to at or below the y-axis.

The example graph of FIG. 7 further includes a uniform light mode 706. The uniform light mode line 706 is the line that has a relatively constant light on the ground/crop during the morning hours (e.g., 6 am to 10 am) and the afternoon hours (e.g., 2 pm to 6 pm). As described elsewhere herein, in the uniform light mode, the solar trackers are rotated such that approximately the same amount of light is provided on the ground/crop over a specified period of time. In the example of FIG. 7, the solar trackers may not be able to rotate to ensure a uniform amount of light on the ground/crop during the mid-day hours (e.g., 10 am to 2 pm). As with the maximum light mode 702, various factors can prevent the solar trackers from enabling the light on the ground/crop to be uniform over all times of day, such as the angle of the sun relative to the solar trackers, the maximum rotation of the solar trackers, the geographical location of the crop and solar trackers, the height of the crop, the height of the solar trackers, the width of the solar trackers, the distance between rows of solar trackers, etc. Thus, while the amount of light on the ground/crop during the mid-day hours (e.g., 10 am to 2 pm) will have some values, the values are not specifically illustrated for the solar trackers operating in the uniform light mode due to one or more of the factors listed.

The example of FIG. 7 additionally includes the thermal optimal mode 708. The thermal optimal mode line 708 is the line that has periodicity between being at or below the y-axis and almost reaching the maximum light mode line 702. As described elsewhere herein, in the thermal optimal mode (i.e., the first thermal optimal mode), the solar trackers can be rotated between angles that maximize an amount of light on the ground/crop (e.g., to increase temperature of the ground) and angles that maximize an amount of light on the solar trackers to maximize energy production. Accordingly, the thermal optimal mode line 708 oscillates between nearly maximizing an amount of light on the ground/crop and being at or below the y-axis. Because the solar trackers cannot move instantaneously, and because it may be desirable to keep the solar trackers at or near angles that maximize light on the ground/crop for a period of time, the thermal optimal mode line 708 is generally rounded at its peaks. As with the maximum light mode 702 and the uniform light mode 706, various factors can prevent the solar trackers from continuing the thermal optimal mode 708 during, for instance, the mid-day hours (e.g., 10 am to 2 pm). Thus, while the amount of light on the ground/crop during these hours will have some values, the values are not specifically illustrated for the solar trackers operating in the thermal optimal mode due to such factors.

Method examples described herein can be machine or computer-implemented at least in part, such as using the controller, or using other systems, devices, or components discussed herein. Some examples can include a computer-readable medium or machine-readable medium encoded with instructions operable to configure a solar system to perform the methods and functions of the solar system described herein. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present applicant also contemplates examples in which only those elements shown or described are provided. Moreover, the applicant also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations.

1. A method of operating a solar plant, the solar plant including a plurality of solar trackers, each of the plurality of solar trackers being located proximate to one or more crops planted in the ground and configured to selectively shade the one or more crops, the method comprising:
receiving an input for a specified amount of light during a specified timeframe, the specified amount of light being a portion of total insolation received by the plurality of solar trackers during the specified timeframe;
adjusting one or more angles of the plurality of solar trackers during the specified timeframe to increase an amount of insolation on the one or more crops by at least the specified amount of light; and
adjusting the one or more angles of the plurality of solar trackers to one or more PV-optimized angles outside of the specified timeframe, the one or more PV-optimized angles corresponding to angles that maximize energy production of the plurality of solar trackers.

2. The method of claim 1, wherein receiving the input further comprises receiving, via a user interface, a selection of a mode of operation for the plurality of solar trackers.

3. The method of claim 2, wherein the mode of operation is PV optimal, maximum light, uniform light, or thermal optimal.

4. The method of claim 3, wherein in the uniform light mode of operation, the amount of insolation on the one or more crops is approximately equivalent to an amount of insulation received at the plurality of solar trackers during the specified timeframe via the adjusting of the one or more angles of the plurality of solar trackers.

5. The method of claim 3, wherein in the maximum light mode of operation, the amount of insulation on the one or more crops is maximized relative to an amount of insulation received at the plurality of solar trackers during the specified timeframe via the adjusting of the one or more angles of the plurality of solar trackers.

6. The method of claim 3, wherein the thermal optimal mode of operation, the adjusting of the one or more angles of the plurality of solar trackers during the specified timeframe comprises periodically stopping rotation of the plurality of solar trackers and otherwise adjusting the one or more angles of the plurality of solar trackers to one or more PV-optimized angles.

7. The method of claim 1, further comprising receiving crop information; and
wherein adjusting the one or more angles during the specified timeframe is based on the crop information.

8. The method of claim 7, wherein the crop information comprises one or more of a type of crop or a crop height.

9. The method of claim 1, further comprising determining, based on the input, a predicted change in electrical energy generated by the plurality of solar trackers and displaying the predicted change via a user interface.

10. The method of claim 1, further comprising:
measuring insolation at the ground below the plurality of solar trackers; and
adjusting the one or more angles during the specified timeframe based on the measured insolation at the ground.

11. The method of claim 1, further comprising:
receiving a stow command; and
outputting a stow control signal to adjust one or more orientations of the plurality of solar trackers to a stow angle.

12. A method of operating a solar plant including a plurality of solar trackers comprising:
receiving, at a user interface, an input for a first amount of insolation during a first specified timeframe, the first amount of light corresponding to a portion of total insolation to be received by the plurality of solar trackers during the first specified timeframe, the input corresponding to a change in operation of the plurality of solar trackers during the first specified timeframe;
determining a predicted change in total insolation received by the plurality of solar trackers based on the input for the first amount of light during the first specified timeframe;
determining a predicted change in total insolation received at the ground below the plurality of solar trackers based on the input for the first amount of light during the first specified timeframe;
displaying the change in the total insolation received by the plurality of solar trackers via the user interface;
displaying the change in the total insolation received at the ground below the plurality of solar trackers via the user interface; and
outputting a control signal, the control signal configured to adjust one or more orientations of the plurality of solar trackers to change the total insolation received by the plurality of solar trackers based on the input for the first amount of light during the first specified timeframe.

13. The method of claim 12, further comprising receiving crop information at the user interface.

14. The method of claim 13, wherein:
determining the predicted change in total insulation received by the plurality of solar trackers is based in part on the crop information; and
determining a predicted change in total insolation received at the ground below the plurality of solar trackers is based in part on the crop information.

15. The method of claim 12, wherein the control signal adjusts the one or more orientations of the plurality of solar trackers to maintain a uniform distribution of insolation on the ground during the first specified timeframe.

16. The method of claim 12, wherein the predicted change in total insolation received by the plurality of solar trackers is determined using weather forecast data and solar position data for the first specified timeframe.

17. A solar plant system comprising:
a first row of solar trackers configured to rotate about a first axis;
a second row of solar trackers configured to rotate about a second axis, the second axis being substantially parallel to the first axis, the second row of solar trackers being spaced apart from the first row of solar trackers by a first distance;
one or more crops planted between the first row of solar trackers and the second row of solar trackers; and
a controller in communication with the first row of solar trackers and the second row of solar trackers, the controller configured to:
determine a predicted maximum amount of insolation received by one or more of the first row of solar trackers, the second row of solar trackers, or at the one or more crops during one or more timeframes;
receive an input for a first specified amount of light during a first specified timeframe, the first specified amount of light being a portion of the maximum amount of insolation received at the first row of solar trackers and/or the second row of solar trackers during the first specified timeframe;
control the first row of solar trackers and/or the second row of solar trackers to rotate during the first specified timeframe to increase an amount of insolation on the one or more crops by at least the first specified amount of light; and
control the first row of solar trackers and/or the second row of solar trackers to rotate to maximize total energy production of one or both of the first row of solar trackers and the second row of solar trackers outside of the first specified timeframe.

18. The solar plant system of claim 17, further comprising a user interface in communication with the controller, the user interface being configured to receive the input for the first specified amount of light.

19. The solar plant system of claim 18, wherein the user interface is configured to receive a user selection of a mode of operation including PV optimal, maximum light, uniform light, or thermal optimal.

20. The solar plant system of claim 17, wherein the controller is further configured to control the first and second rows of solar trackers to provide a uniform amount of light to the one or more crops during the first specified timeframe.

21. The solar plant system of claim 17, wherein the controller is further configured to control the first and second rows of solar trackers to provide a maximum amount of light to the one or more crops during the first specified timeframe.

22. The solar plant system of claim 17, wherein the controller is further configured to control the first and second rows of solar trackers to provide a set amount of thermal energy to the one or more crops during the first specified timeframe.
